(19) United States
(12) Patent Application Publication
(10) Pub. No.: US 2017/0130892 A1
(43) Pub. Date: May 11, 2017

(54) Coupling Support

(71) Applicant: New Gencoat, Inc., Sussex, WI (US)

(72) Inventor: Roger E. Salyers, Lisbon, WI (US)

(21) Appl. No.: 15/346,990

(22) Filed: Nov. 9, 2016

Related U.S. Application Data
(60) Provisional application No. 62/252,772, filed on Nov. 9, 2015.

(51) Int. Cl. F16M 13/02

(52) U.S. Cl. CPC F16M 13/02; F16M 2200/02; F16M 2200/06

(57) ABSTRACT

A drive shaft coupling support assembly includes a support beam mounted on a roller support and a housing movable along the beam between use and non-use positions. The housing includes a camming mechanism that can engage and securely hold the drive, shaft in a stationary position relative to the roller support to enable the replacement driven shaft to be readily re-engaged with the drive shaft. The camming mechanism is operable without the use of any tools. and the support assembly is able to be secured directly to a roller support to minimize the complexity of the assembly utilized to hold the drive shaft.

### CROSS-REFERENCE TO RELATED APPLICATIONS

This application claims priority from U.S. Provisional Patent Application Ser. No. 62/252,772, filed on Nov. 9, 2015, the entirety of which is expressly incorporated by reference herein for all purposes.

### FIELD OF THE INVENTION

The present invention relates to power transmission systems, and more specifically to a support for use in changing out driven rollers that are connected to a drive shall of the power transmission system.

### BACKGROUND OF THE INVENTION

In order to couple a drive shaft to a driven shaft, such as, used in driving rollers in a roll coating machine, many different types and constructions for the power transmission couplings have been developed. The coupling securely engages the drive shaft to the driven shaft such that the rotation of the drive shaft is effectively transferred to the driven shaft in order to rotate the driven shaft and the roller secured thereto.

One concern with machines of this type is the issues that are presented when it is necessary or desired to change the roller and associated driven shaft that are connected to the drive shaft. In particular, due to the heavy weight of the drive shaft, it is, necessary to provide a separate support mechanism to engage and hold the drive shaft in position when disengaged from the driven shaft and roller.

The prior art solution to provide the support to the drive shaft during replacement of the driven shaft/roller is to have a separate support structure present around the drive shaft that can be secured to the drive shaft. The support structure normally takes the form of a gantry disposed and/or anchored above the drive shaft that supports a chain or other similar structure that depends downwardly from the gantry for engagement around the drive shaft. The chain is positioned around the drive shaft to support the drive shaft as it is disengaged and displaced from the roller. The drive shaft can be maintained in the displaced location by the chain until replacement of the roller or placement of the new roller is completed, whereupon the drive shaft can be moved back into position relative to the roller and re-engaged therewith. Other support structures include pedestals or similar structures that are positioned beneath and engaged with the drive shaft that allow for the support and movement of the drive shaft relative to the roller to enable removal and/or replacement of the roller while the drive shaft is disengaged.

However, in these prior art support devices and structures, the structures are often very complicated and unwieldy to move into position and engage/disengage from the drive shaft. For example, with the structure including the chain supported by the gantry, the structure of the gantry must be formed to be able to adequately support the weight of the drive shaft, which can be in excess of 40 lbs, during the initial disengagement of the drive shaft from the roller and during the movement of the drive shaft relative to the roller. As such the structures of prior art drive shaft supports are significantly limiting in that they require significant space for the structure to be positioned and moved within in order to adequately support the drive shaft. In addition, the positioning, engagement and movement of the support structure requires multiple tools in order to securely engage the support structure with the drive shaft.

Thus, it is desirable to develop a support for a drive shaft that has a more compact structure but is still capable of functioning in an effective and efficient manner in holding a drive shaft when disconnected from a driven shaft and roller.

### SUMMARY OF THE INVENTION

Therefore according to an exemplary embodiment of the present invention, a drive shaft coupling support clamp assembly is provided that can be quickly and easily engaged and disengaged from the drive shaft coupling without the need for any tools or additional implements. The shaft coupling support clamp assembly overcomes the aforementioned disadvantages as it has a simple construction that is mountable directly on the roller support on which the roller and driven shaft are disposed.

In one exemplary and non-limiting embodiment of the invention, to enable the clamp to be positioned where necessary relative to the drive shaft coupling, the shaft coupling support clamp assembly is movably mounted on a support arm that is connected directly to the roller support in alignment with the drive shaft. The coupling clamp assembly is movable on the support arm between use and non-use positions.

In another exemplary and non-limiting embodiment of the invention, to engage and retain the drive shaft in position on the support are when disengaged from the driven shaft, the coupling clamp assembly includes a caroming lock, mechanism that can engage and securely hold the drive shaft coupling in a stationary position relative to the roller support to enable the replacement driven shaft and/or roller to be readily re-engaged with the drive shaft. The lock mechanism can be manually engaged with the drive shaft without the need for tools, and includes a safety lock that can retain the lock mechanism in the engaged position to prevent inadvertent disengagement of the lock mechanism from the drive shaft.

Other aspects, advantages and features of the present invention, will be made apparent from the following detailed description taken together with the drawing figures.

### BRIEF DESCRIPTION OF THE DRAWINGS

The drawings illustrate the best mode currently contemplated of practicing the present invention,

In the drawings:

FIG. 1 is a partially broken-away side plan view of a shaft support clamp assembly according to one exemplary embodiment of the invention;

FIG. 2 is a front plan view of the shaft support clamp assembly of FIG. 1 in a disengaged position;

FIG. 3 is a front plan view of the shaft support clamp assembly of FIG. 1 in an engaged position;

FIG. 4 is a perspective view of the shaft support clamp assembly of FIG. 1 in a disengaged position;

FIG. 5 is a perspective view of the shaft support clamp assembly of FIG. 1 in an engaged position;

FIG. 6 is a partially broken away, perspective view of locking tab on the shaft support clamp assembly engaged with a drive shaft.

### DETAILED DESCRIPTION OF THE INVENTION

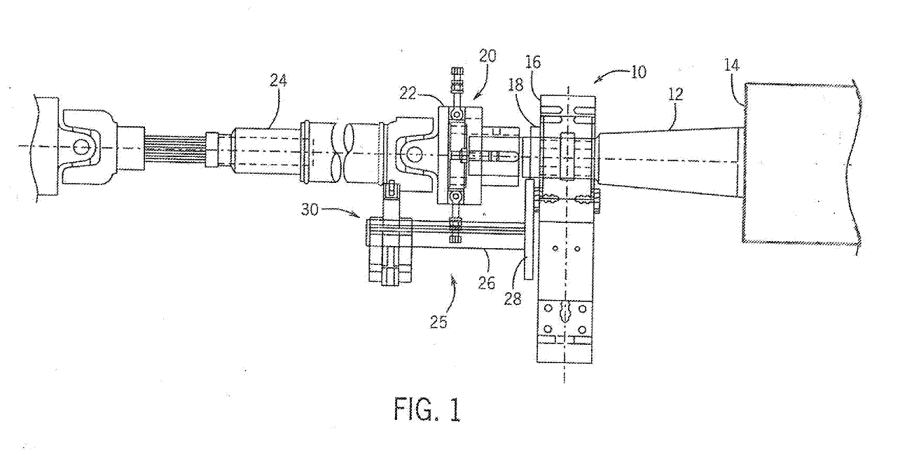

With reference now to the, drawing figures in which like reference numbers designate like parts throughout the disclosure, a roller support assembly is indicated generally at 10 in FIG. 1. The roller support assembly 10 is utilized to support opposed ends of a driven shaft 12 to which a roller 14 or other similar structure is mounted for rotation therewith. The support assembly 10 include a pair of collars 16 (only one of which is shown in FIG. 1) that supports an end 18 of the driven shaft 12 therein. The collars 16 enable the ends 18 of the driven shaft 12 to rotate within the collars 16, such that the driven shaft 12 and roller 14 can be rotated with respect to the roller support assembly 10.

One end 18 of the driven shaft 12 includes a coupling 20 that is utilized to engage the end 18 of the driven shaft 12 with an end 22 of a drive shaft 24. The coupling 20 can have many alternative structures, but is used to engage the drive shaft 24 with the driven shaft 12, such that the rotation of the drive shaft 24 is transmitted through the coupling 20 to rotate the driven shaft 12 and the roller 14. Opposite the coupling 20, the drive shaft 24 is connected to a suitable motor or drive member (not shown) that rotates the drive shaft 24 at the desired speed when operated.

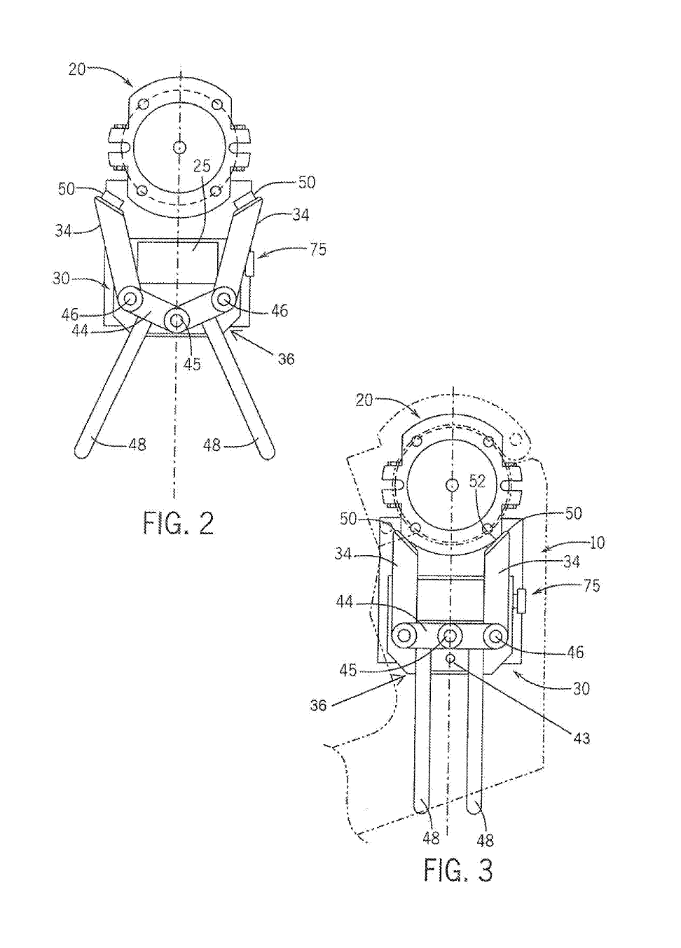

Looking now at FIGS. 2-6, the roller support assembly 10 includes a shaft coupling support clamp assembly 25 disposed on and extending outwardly from the roller support assembly 10. The shaft coupling support assembly 25 includes a support arm or beam 26 that is engaged directly with and extends outwardly from the roller support assembly 10 in alignment with the driven shaft 12 and the drive shaft 24 below the collar 16. The beam 26 can be formed integrally with the structure of the support assembly 10, or can be disposed on a mounting plate 28 that can be bolted or otherwise secured to the support assembly 10 in a known manner to properly positon the beam 26 on the roller support 10, as shown in the illustrated exemplary embodiment. The beam 26 is also shown to have a generally rectangular cross-section in the illustrated exemplary embodiment, but other configurations for the beam 26 are also possible, such as a beam 26 having a circular cross-section, as desired. Mounted to the beam 26 is a shaft support clamp 30. The shaft support clamp 30 includes a housing 32 that in the illustrated exemplary embodiment is U-shaped to define an opening 33 between the housing 32 and a plate 35 secured over the top of the housing 32. The housing 32 is positioned around the beam 26 which extends though the opening 33 and is slidable with respect thereto, such as by rollers or other structures positioned on the housing 32.

The housing 32 also includes a pair of clamping arms 34 extending upwardly out of the housing 32 on opposed sides of the housing 32. The arms 34 are interconnected to one another by a camming mechanism 36 disposed within the housing 32. In addition to the arms 34, the camming mechanism 36 is connected to handles 38 extending outwardly form the housing 32 opposite the arms 34 as well as to a housing lock pin 40 and a cam lock pin 42.

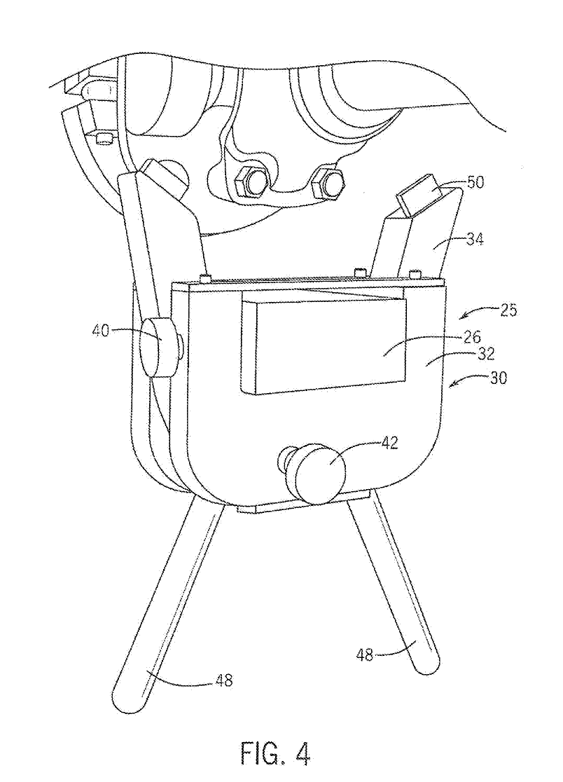

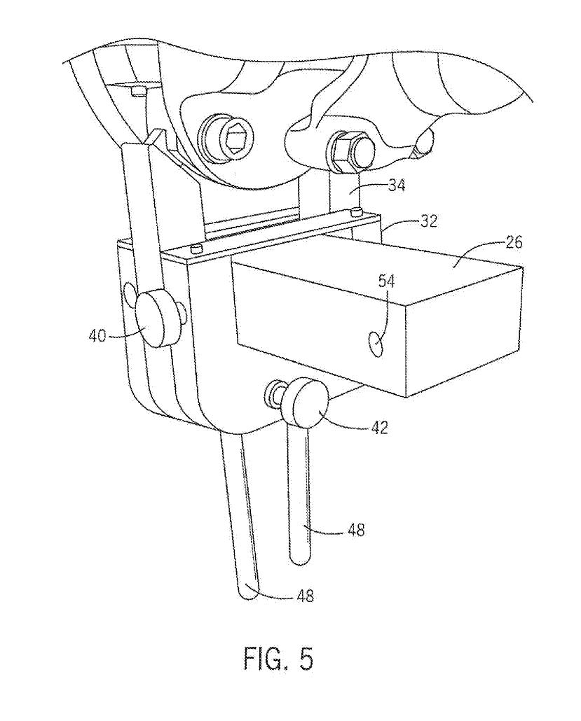

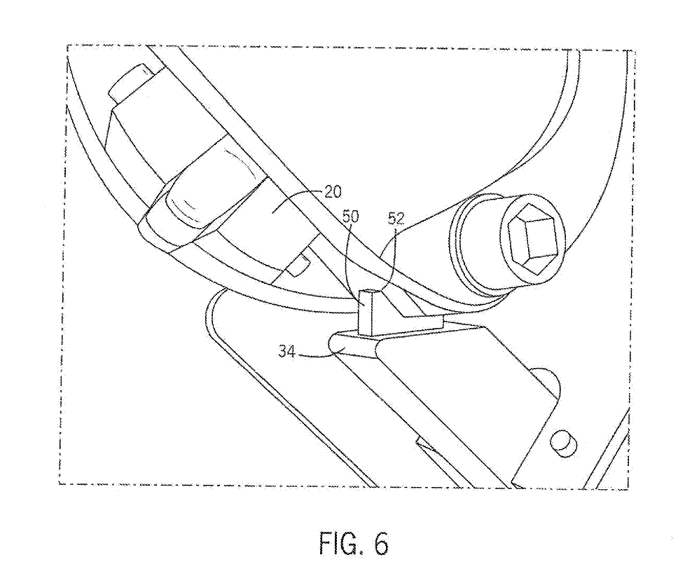

The camming mechanism 36 is operable to enable the arms 34 to be moved from a disengaged position as shown in FIGS. 2 and 4 to an engaged position as shown in FIGS. 3 and 5. The mechanism 36 includes a pair of central members 44 that are pivotally secured to, each other at pivot pin 45 and are each secured to one of the arms 34 by pivot pins 46. Pivot pins 46 are fixed to the housing 32 such that the central members 44 can move from an extended position as best shown in FIG. 2 to a camming position as best shown in FIG. 3. In the positon of FIG. 3, the central members 44 provide a cam lock to the mechanism 36. This lock is maintained by the cam lock pin 42. The cam lock pin 42 is biased inwardly into the housing 32, such as by a spring (not shown) and is disposed on, the housing 32 within a bore 43 located just below the locking positon of the central members 44. Thus, when the central members 44 are moved into the locking positon of FIG. 3, the biased cam lock pin 42 moves into the housing 32 through the bore 43 to a position just below one of the central members 44, preventing the movement of the central members 44 out of the locking position. When the cam lock pin 42 is diseneaged by pulling the pin 42 outwardly from the housing 32 against the bias, of the spring, the movement of the central members 44 is no longer restricted, such that the central members 44 can pivot around the pins 46 to the unlocked or disengaged position of FIG. 2.

To move the central members 44 between the locked and unlocked positions, the handles 48 are grasped and pivoted in the direction desired for the movement of the central members 44. The handles 48 are each directly engaged with one of the central members 44, such that the movement of the handles 48 directly moves the associated central member 44 as desired. However, in the locking position, the handles 48 cannot be moved until the cam lock pin 42 has been disengaged, to enable free movement of the central members 44 within the housing 32.

The arms 34 are also connected to the pivot pins 46, such that the movement of the central members 44 is translated via the pivot pins 46 to the arms 34. As such when the central members 44 are moved towards the locking position of FIG. 2, the pivot pin 45 moves along a channel 47 formed in the housing 32 to enable the arms 34 to pivot and move inwardly towards one another due to the corresponding movement of the pivot pin 45 and the rotation of the pivot pins 46. Conversely, when the central members 44 are moved to the position of FIG. 3, the arms 34 are correspondingly rotates away from one another by the rotation of the pins 46.

To securely engage the arms 34, and thus the shaft support clamp assembly 25 with the drive shaft 24, opposite the pivot pins 46 the arms 34 each include a locking tab 50. The tabs 50 can be shaped as desired. but in, the illustrated embodiment is shaped complementary to a notch 52 formed in the coupling 20. as best shown in FIGS. 5 and 6. When the central members 44 are moved into the locking position using the handles 48, the arms 34 move towards the coupling 20 to engage the tabs 50 within the respective notches 52. The cam lock pin 42 holds the arms 34 and tabs 50 within the notches 52, thereby maintaining the positon of the coupling 20 and the drive shaft 24 with respect to the support assembly 10. In this position the coupling 20 can be disengaged, allowing the driven shaft 12 and roller 14 to be removed and replaced, while the drive shaft 24 is held by the support clamp assembly 25. Further, because the assembly 25 is fixed to the support assembly 10, the weight of the driven shaft 24 is easily supported by the support assembly 10.

When the assembly 25 is disengaged from the coupling 20, the assembly 25 can be slid along the beam 26 to a non-use position where the assembly 25 will not interfere with the normal operation of the drive shaft 24. The assembly 25 can be held in this non-use position by the housing lock pin 40 which can be engaged within an aperture 54 disposed in the beam 26 to hold the support clamp 30 at the desired location. A similar bore (not shown) can be disposed at a location on the beam 26 where the clamp 30 is to be positioned when engaged with the coupling 20 to use the housing lock pin 40 to hold the housing 32 and clamp 30 at the required location for engagement of the tabs 50 with the notches 52.

While the concepts of the present disclosure will be illustrated and described in detail in the drawings and description, such an illustration, and description is to be considered as exemplary and not restrictive in character, it being understood that only the illustrative embodiments are shown and described and that all changes and modifications that come within the spirit of the disclosure are desired to be protected. There are a plurality of advantages that may be inferred from the present disclosure arising from the various features of the apparatus, systems, and methods described herein. It will be noted that alternative embodiments of each of the apparatus, systems, and methods of the present disclosure may not include all of the features described yet still benefit from at least some of the inferred advantages of such features. Those of ordinary skill in the art may readily devise their own implementations of an apparatus, system, and method that incorporate one or more of the features of the present disclosure and fall within the spirit and, scope of the disclosure as defined by the appended claims.

I claim:

1. A drive shaft coupling support assembly comprising:
a) a support beam adapted to be operably connected to a roller support;
b) a housing mounted on the beam;
c) a camming mechanism disposed within the housing and adapted to selectively engage and hold a drive shaft.

2. The drive shaft coupling support assembly of claim 1 further comprising a pair of arms operably connected to the camming mechanism and engagable with the drive shaft to hold the drive shaft on the support assembly.

3. The drive shaft coupling support assembly of claim 2 wherein the pair of arms arc to held in an engaged position by the operation of the camming mechanism.

4. The drive shaft coupling support assembly of claim 2 further comprising locking tabs disposed on the pair of arms opposite the emitting mechanism that are selectively engagable with notches formed on the drive shaft.

5. The drive shaft coupling support assembly of claim 1 wherein the housing is slidable with respect to the beam.

6. The drive shaft coupling support assembly further comprising a housing locking member disposed on the housing and selectively engageable with the beam.

7. The drive shaft coupling support assembly of claim 6 wherein the housing locking member comprises a biased pin disposed on the housing.

8. The drive shaft coupling support assembly of claim 7 further comprising at least one bore in the beam that is engageable with the biased pin.

9. The drive shaft coupling support assembly of claim 1 further comprising a camming mechanism locking member selectively engageable between the housing and the camming mechanism.

10. The drive shaft coupling support assembly of claim 9 wherein the camming mechanism locking member comprises a biased pin disposed on the housing and extending through a bore in the housing into selecteive engagement with camming mechanism.

11. The drive shaft coupling support assembly further comprising a support plate adapted to be secured to the roller support and to which the beam is connected.

12. A method of holding a drive shaft when disengaged from a driven shaft engaged with a roller supported by a roller support, the method comprising the steps of:
a. providing the drive shaft coupling support assembly of claim 1;
b. sliding the housing along the beam to an engagement position relative to the drive shaft coupling;
c. engaging the camming mechanism with the drive shaft coupling to, hold the coupling relative to the drive shaft coupling support assembly.

13. The method of claim 12 wherein the camming mechanism includes a pair of arms operably connected to, the camming mechanism, and wherein the step of engaging the camming mechanism comprises moving the arms into enagement with the coupling.

14. The method of claim 13 wherein the step of moving the arms into engagement with the coupling comprises engaging tabs on the arms within notches disposed on the coupling.

15. The method of claim 12 further comprising the step of engaging a camming mechanism locking member to lock the camming mechanism in engagement with the coupling.

16. The method of claim 12 further comprising the step of engaging a housing locking member with the beam after sliding the housing along the beam to the engagement position.
